(19) United States
(12) Patent Application Publication
(10) Pub. No.: US 2013/0213195 A1
(43) Pub. Date: Aug. 22, 2013

(54) TOOL

(71) Applicants: Stefan Czympiel, Remscheid (DE); Heinz Dieter Baumann, Remscheid (DE)

(72) Inventors: Stefan Czympiel, Remscheid (DE); Heinz Dieter Baumann, Remscheid (DE)

(73) Assignee: Richard Abr. Herder GmbH & Co. KG, Solingen (DE)

(21) Appl. No.: 13/696,379

(22) PCT Filed: Apr. 12, 2011
(86) PCT No.: PCT/EP2011/001810

§ 371 Date: Mar. 11, 2013

(30) Foreign Application Priority Data
May 7, 2010 (DE) 10 2010 019 878.1

(51) Int. Cl. B25B 23/142

(52) U.S. Cl. CPC B25B 23/1422
USPC 81/467

(57) ABSTRACT

The invention relates to a tool, tool, in particular a screwing tool (1), comprising a handle (2), a working part (5) that is connected to the handle and that is used to open or close a threaded connection, and a display device (10) that displays a working value, for example a tightening torque of the threaded connection, wherein the display device (10) has at least two representations of the working value, in particular the tightening torque. In order to develop a generic tool in such a way that incorrect operation can be prevented with sufficient reliability, a covering device (17) is provided, which covers at least one working value and/or is designed in such a way that only one working value can be displayed in the display device (10).

The invention relates to a tool, in particular a screwing tool, comprising a handle, a working part that is connected to the handle and that serves to open or close a threaded connection, and a display device that displays a working value, for example a tightening torque of the threaded connection, wherein the display device comprises at least two representations of the working value, in particular the tightening torque.

Such tools are known from the state in the art and they are in particular so called torque screwing tools which comprise a handle and a working part, which working part is usually composed of a square which is placed in a head in a rotatable manner and which can be blocked in dependence on the working operation, namely the opening or closing of a threaded connection. Furthermore, such tools comprise a device which limits the tightening torque of the tool in dependence on the admissible tightening torque of the threaded connection. Usually, the user receives a signal (audible, visible, sensible) from the tool and/or the force flow is completely or temporally interrupted. Thanks to this design, the tool can be set to the admissible tightening torque of the threaded connection, such that a too high tightening torque is avoided. Such proceedings are for example known in the assembly of light metal wheels on motor vehicles.

Such tools furthermore comprise display devices which display corresponding tightening torques during the handling of the tool. As different dimensions, such as for example Newton meter (Nm) or lbf ft., are used for the display of tightening torques, it is common practice to display several, at least two working values on the display device.

But sometimes this display causes problems, since it cannot be excluded that the provided tightening torque is indicated in the one dimension whereas the tool is handled in the other dimension, such that a too high or a too low tightening torque will be transferred to the threaded connection.

Another problem of such tools is that the tightening torques can be adjusted and that the adjusting of such tightening torques does not permanently function correctly, such that such tools have to be calibrated from time to time. Here, mistakes could also happen due to a confusion of the measuring units.

Based upon the above mentioned state of the art, it is the object of the invention to design a generic tool such that the above described incorrect handling can be excluded with sufficient reliability.

A solution of this problem provides that a covering device is provided which covers at least one working value and/or is designed in such a way that only one working value can be displayed in the display device.

Accordingly, a tool, in particular a screwing tool having a display device complementarily comprises a covering device which can be moved such that only maximum one working value of the possible working values will always be visible. Hereby, the working value, in particular the dimension can be pre-set which coincides with the working value or the dimension of the tightening torque provided for a certain threaded connection. Hereby, incorrect operations due to different dimensions can be excluded to a large extend.

The display device is preferably placed in the area of the handle, such that the operating person can see the display device in an excellent manner. Preferably, the covering device is a slide which can be displaced with respect to the display device between at least two adjusting positions. Principally, the covering device can also assume more than two positions with respect to the display device. Herein, it is only important that the covering device always makes one sole working value visible in the display device, such that incorrect operations due to different working values can be excluded.

But it is also possible that the slide cannot be displaced but can be slipped on the handle or a scale frame, wherein also in this case, the slide is designed such that it only leaves one partial area of the display device visible, namely such a partial area which correspondingly only enables the display of one working value.

According to another embodiment of the invention it is provided that the covering device is adapted to an outer contour of the handle and is placed on the handle such that it can be displaced with respect to the handle in the circumferential direction and/or longitudinal direction of the handle. The covering device preferably comprises a reversing switch or finger projection which can be for example actuated by means of the thumb in order to set the covering device to the corresponding position before operating the tool.

According to another feature of the invention it is provided that the display device is placed in the area of an opening in the region of the handle and/or the working part and can be displaced, preferably rotated with respect to this opening such that only a due working value is visible in the opening. In this embodiment, the display device is not partially covered by a slide that can be displaced or slipped on, but a carrier with the working values is displaced with respect to the display device, for example in form of an opening in the handle, such that also in this case, only a set working value will be visible by means of the display device.

The covering device can be designed with an access authorization device such that a displacement of the covering device is only possible with an access authorization. In this way it is assured that the covering device is not moved in an unintended manner during operation, which could cause incorrect operations due to different dimensions to take place after the change.

As already mentioned, it is provided according to another feature of the invention that such a tool is designed as torque screwing tool which for example comprises a receiver in form of a square for shell tools. But it is also possible that such a tool is a screw driver or corresponding tool inserts, so called bits-in can be placed in corresponding receivers.

Complementarily it is provided for a tool according to the invention that the covering device can be displaced by means of a reversing switch, wherein the reversing switch is preferably guided in a guidance. The mobility of the covering device is defined by the guidance. The reversing switch can be moved between two adjusting positions which are such positions with respect to the covering device which only leave one portion of the display device visible. The guidance of the reversing switch permits a simple handling.

According to another feature of the invention it is provided that the reversing switch can be locked to the handle in its end positions in the guidance. This design prevents an unintended displacement of the covering device during the operation of the tool, wherein there would be a great risk that no one would become aware of such an unintended displacement during the further work with the tool, such that afterwards incorrect operations would be executed with the tool.

The reversing switch is preferably designed with recesses on the end sides, into which spring-loaded locking elements which are placed in the handle, in particular balls or pins comprising a hemispheric end, engage. Alternatively it can be provided that spring-loaded locking elements, in particular balls or pins comprising a hemispheric end are placed in the reversing switch and engage in the recess of the handle. Thanks to the locking elements, the reversing switch and thus the covering device attached thereto are fixed in the opposite end positions. The fixation can only be loosened by applying a greater force which is usually not generated by working with the tool. This force is rather deliberately generated when the reverse switch is actuated for displacing the covering device, such that here an intended action takes place together with the adjustment of the tool. The locking elements can be either placed in the reversing switch or in the handle and can be for example respectively composed of one spring-loaded ball which is pushed by the spring into a corresponding recess in the due end position. Alternatively, also a pin can be provided which comprises a hemispheric end which is facing the recess. The design of the locking elements as balls or as pins comprising a hemispheric end simplifies the handling and the assuming of the locking position is clearly indicated. Other locking elements, such as spring-loaded slides or pre-stressed plastic elements having locking projections which engage in corresponding recesses are of course also possible. Furthermore, it is not imperative that the locking elements are placed on the end sides. It is also possible to locate a locking element in the central portion of the reversing switch, wherein it has to be taken care of the fact that both locking positions can be clearly noticed and furthermore enable a clear fixation of the reversing switch in the guidance.

Other features and advantages of the invention will become apparent from the following description of the associated drawing, in which preferred embodiments of the invention are represented. In the drawing:

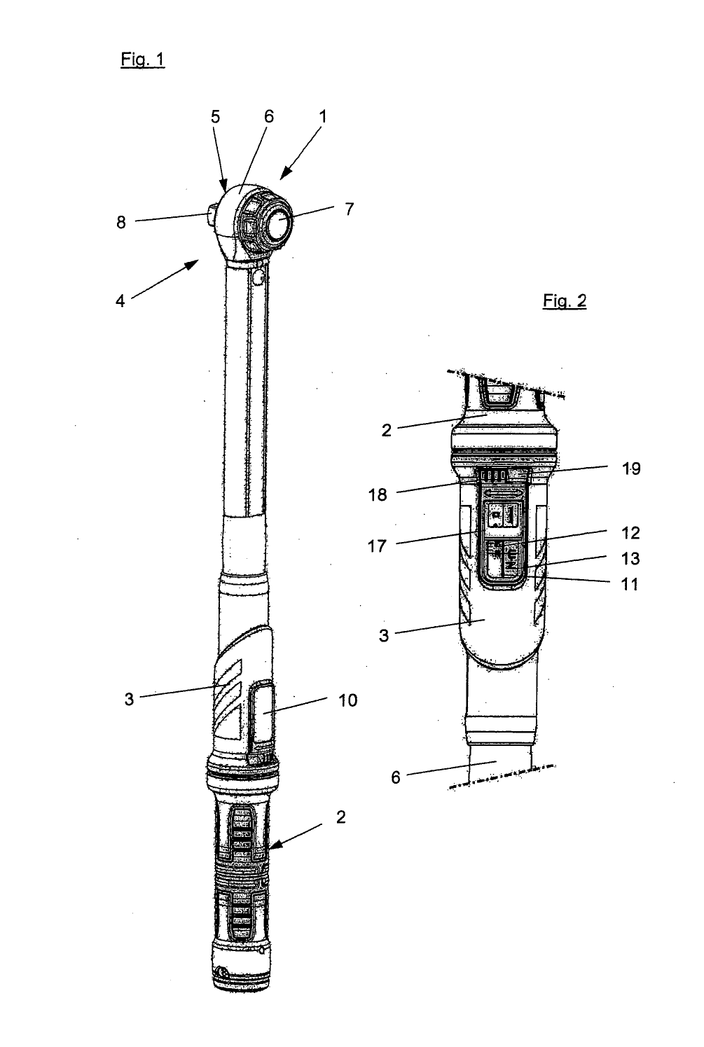

FIG. 1 is a perspective view which shows a screwing tool;

FIG. 2 is a perspective view which shows a section of a handle of the screwing tool according to FIG. 1;

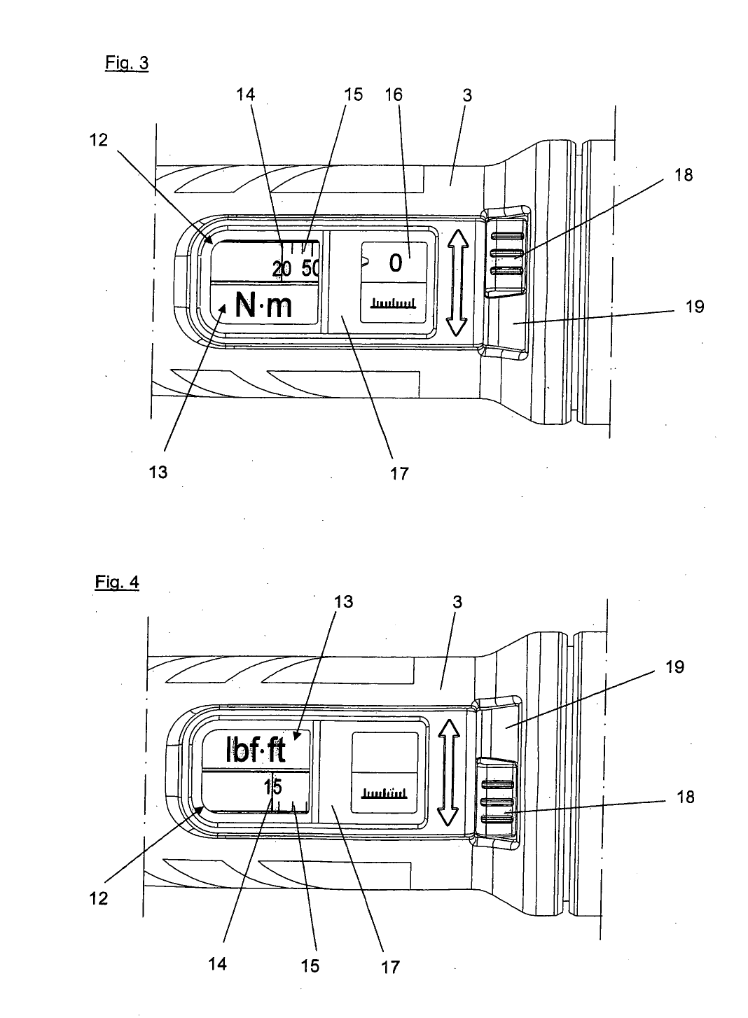

FIG. 3 shows a portion of the handle according to FIG. 2 comprising a display device and a covering device in a first position and

FIG. 4 shows the display device and the covering device according to FIG. 3 in a second position.

FIG. 1 shows a screwing tool 1 in form of a torque screwing tool comprising a handle 2 which essentially comprises a circular cross section. The handle 2 is preferably made of one or more synthetic materials.

The screwing tool 1 comprises a working part 5 of usual design at an end 4 which is connected to the handle 2. The working part 5 consists of an essentially annular housing 6 into which a rotatable element 7 is inserted, the turnability of which with respect to the housing 6 can be alternatively determined in both turning directions, and which element 7 comprises a drive 8 having a square cross section, which drive can be connected to no further represented tool nuts which comprise different sizes of the jaw and which serve for the connection to the no further represented threaded connection. Furthermore, working parts in form of a pin of a rectangular receiver or other no further described receivers are known in order to fix tools having different shapes and/or sizes of jaw.

The drive 8 can be set with respect to its transmittable torque by for example rotating two sections of the handle 2 with respect to each other.

The technique of such a torque screwing tool is sufficiently known and in this connection reference is made to DE 203 15 000 U1 which discloses an embodiment of such a torque screwing tool.

The screwing tool 1 according to FIG. 1 furthermore comprises a display device 10 which serves for displaying various working values. Usually, the tightening torques which are to be transferred from the screwing tool 1 to the threaded connection are displayed by such display devices 10.

A detailed representation of the display device 10 results from FIGS. 2 through 4 which will be described in the following.

From FIG. 2 it becomes apparent that the display device 10 comprises a first scale which consists of a value indication 12 and a field of units 13 placed next to it. The value indication 12 comprises a fixed reference line 14 (FIGS. 3 and 4) as well as a scaling 15 which can be moved with respect to the reference line 14 (FIGS. 3 and 4).

Besides the first scale 11, a second scale which is designed as vernier scale 16 can be provided which is located in the longitudinal direction of the handle 2 above the first scale 11. This vernier scale 16 and the position of the reference line indicate the set tightening torque.

In FIG. 2, only a part of the display device 10 is represented which is divided into the part represented in FIG. 2 or FIG. 3 and the part represented in FIG. 4 which comprises the display of the tightening torque in another dimension, namely lbf·ft, whereas in FIGS. 2 and 3 it is visible that the tightening torque is represented in the dimension Nm (Newtonmeter). Other dimensions, such as lbt·in, Kgm, Kgfm, Kpm or the like are possible.

In the area of the display device 10, the screwing tool 1 comprises a covering device 17 which is a slide and can be displaced radially between two end positions with respect to the scale frame 3. For this purpose, the covering device 17 is designed with a reversing switch 18 which is guided in a guidance 19 of the handle 2, wherein the guidance 19 defines the two end positions.

Herein, the reversing switch 18 can be actuated in an especially grip-favourable manner by means of the thumb of an operating person.

The covering device 17 is displaced by means of the reversing switch 18 such that always one sole working value will be visible in the display device 10, whereas the second working value will be covered, wherein the working values are indications of the set tightening torque in a dimension Nm or lbf·ft. The covering of one working value excludes incorrect readings. Herein, it has to be considered that the operating person who works with such screwing tools 1 has got a particular tightening torque prescribed for the concerned threaded connection. For not exceeding this tightening torque to a large extend, the operating person has to know the actually set tightening torque. Since the tightening torques are indicated in different dimensions, it frequently happens that incorrect operations of such screwing tools 1 are executed, in which for example a pre-determined tightening torque in Nm has been set in lbf·ft on the scale. This can lead to incorrectly tightened threaded connections.

FIGS. 3 and 4 show the display device 10 of FIG. 3 in a representation of the actually set tightening torque in Nm and in FIG. 4 in lbf·ft and one can see that the reversing switch 18 is placed at a first end of the guidance 19 in FIG. 3 and at the opposite end of the guidance 19 in FIG. 4. Hereby it becomes visible that the covering device 17 can be displaced with respect to the handle 2, wherein the covering device 17 can be turned around the handle 2 between two end positions. Usually, the vernier scale can only refer to one unit (for ex. Nm) and is thus covered when using the alternative unit.

The above described embodiment according to FIGS. 1 through 4 only represents one embodiment. It is also possible that the covering device 17 is not displaceable with respect to the handle 2 or the scale frame 3, but that the display device 10 can be displaced with respect to an opening in the handle 2 such that only one range of values will be visible via this opening which itself represents the display device 10.

### LIST OF REFERENCE NUMERALS

1 screwing tool
2 handle
3 scale frame
4 end
5 working part
6 housing
7 element
8 drive
10 display device
11 1. scale
12 value indication
13 field of units
14 reference line
15 scaling
16 vernier scale
17 covering device ( . . . covered by the scale frame)
18 reversing switch
19 guidance

1. A tool, in particular a screwing tool, comprising a handle, a working part that is connected to the handle and that serves to open or close a threaded connection, and a display device that displays a working value, for example a tightening torque of the threaded connection, wherein the display device comprises at least two representations of the working value, in particular the tightening torque, characterized in that a covering device is provided which covers at least one working value and/or is designed in such a way that only one working value can be displayed in the display device.

2. A tool according to claim 1, characterized in that the display device is placed in the area of a housing, for example in or on the handle.

3. A tool according to claim 1, characterized in that the covering device is a slide which can be displaced with respect to the display device between at least two end positions.

4. A tool according to claim 1, characterized in that the covering device is adapted to an outer contour of the handle and is placed on the handle such that it can be displaced with respect to the handle in the circumferential direction and/or longitudinal direction of the handle.

5. A tool according to claim 1 characterized in that the display device is placed in the area of an opening in the region of the handle and/or the working part and can be displaced, preferably rotated with respect to this opening such that only a due working value is visible in the opening.

6. A tool according to claim 1, characterized in that the covering device is designed with an access authorization device which enables a displacement of the covering device only with an access authorization.

7. A tool according to claim 1, characterized by a design as torque screwing tool.

8. A tool according to claim 1, characterized in that the covering device can be locked to the scale frame by means of a reversing switch in its end positions in the guidance.

9. A tool according to claim 8, characterized in that the reversing switch is designed with recesses on the end sides, into which spring-loaded locking elements which are placed in the scale frame, in particular balls or pins comprising a hemispheric end, engage or that spring-loaded locking elements, in particular balls or pins comprising a hemispheric end are placed in the reversing switch and engage in recesses of the scale frame.
